(19) United States
(12) Patent Application Publication
(10) Pub. No.: US 2009/0296102 A1
(43) Pub. Date: Dec. 3, 2009

(54) COHERENCE TOMOGRAPHY DEVICE

(75) Inventor: Masami Tamura, Kyoto (JP)

Correspondence Address: STEIN MCEWEN, LLP, 1400 EYE STREET, NW, SUITE 300, WASHINGTON, DC, 20005, US

(73) Assignee: SHOFU INC., Kyoto-shi (JP)

(21) Appl. No.: 12/475,862

(22) Filed: Jun. 1, 2009

(30) Foreign Application Priority Data
Jun. 3, 2008 (JP) 2008-146077

(51) Int. Cl. G01B 11/24

(52) U.S. Cl. 356/512

(57) ABSTRACT

An optical coherence tomography device includes: a light source 1; a light splitting section 2a that splits light-source light emitted from the light source 1 into reference light and measurement light; an interfering section 2a that allows backscattered light of the measurement light backscattered by a measurement object T to interfere with the reference light reflected from a reference mirror so as to generate interference light; a photodetecting section 4 that measures the interference light; an oscillator 91 that modulates the backscattered light and the interference light by applying an ultrasonic wave, a sonic wave or an oscillation to the measurement object T; a demodulating section 53 that demodulates the interference light measured at the photodetecting section 4; and an analyzing section 52 that generates property data showing the optical backscattering property of the measurement object T on the basis of the demodulated interference light and generates image data of the measurement object T.

### CROSS-REFERENCE TO RELATED APPLICATION

This application claims the benefit of Japanese Patent Application No. 2008-146077, filed Jun. 3, 2008, in the Japanese Patent Office, the disclosure of which is incorporated herein by reference.

### BACKGROUND OF THE INVENTION

1. Field of the Invention

The present invention relates to a coherence tomography device for measuring property values in a three-dimensional space of the surface and the interior of a living body by use of the interference principles, processing data of the measurement result, thereby generating two-dimensional or three-dimensional image data showing the structure, composition, material and the like of the interior of the living body.

2. Description of Related Art

Conventionally, in the examinations and diagnoses in the medical field, X-ray equipment, cameras, ultrasonic tomography devices, X-ray CT, MRI and the like have been used. In addition, recently, an idea of measuring an internal tomographic image with an optical coherence tomography device has been presented.

An image obtained in the X-ray equipment is only a transmitted image, and information on an X-ray traveling direction of an object to be measured (hereinafter, referred to as ‘measurement object’) is detected while being overlapped with each other. Therefore, it is difficult to know the internal structure of the measurement object three-dimensionally. Furthermore, since an X-ray is harmful to a human body, an annual exposure dose is limited, and an X-ray is dealt with only by an eligible operator and is used only in a room surrounded by a shielding member of lead, lead glass, or the like.

Since the camera captures only the surface of a biological tissue, information on the biological interior cannot be obtained. The X-ray CT is harmful to a human body in the same way as in the X-ray equipment. In addition, the X-ray CT has poor resolution, and the device is large and expensive. The MRI equipment generally used has poor resolution, and the device is large and expensive. In addition, the MRI equipment cannot photograph the internal structures of hard tissues such as bones and teeth containing no moisture.

The optical coherence tomography device is harmless to a human body, and enables three-dimensional information on a measurement object with high resolution. Therefore, the optical coherence tomography device has been applied to the ophthalmological field such as tomography of a cornea, a retina and the like. Endoscopic optical coherence tomography devices also have been presented. Furthermore, in the field of dentistry, application of the optical coherence tomography devices has been disclosed (see Patent Documents 1-8, Non-Patent Documents 1-10). Hereinafter, the optical coherence tomography device is abbreviated as the OCT device.

The conventional OCT device described above includes a light source, a fiber coupler (spectroscope), a reference mirror, a photodetector, and an operating section. A light beam emitted from the light source is split at the fiber coupler into two beams of reference light and measurement light. The reference light is reflected by the reference mirror and returns to the fiber coupler. The measurement light is subjected to action of reflection, scattering and transmission by a measurement object, and backscattered light (light reflected in a z-direction) composing a part of the measurement light returns to the fiber coupler. Here, the irradiation direction of the measurement light is set to the z-direction. In this manner, the backscattered light returning to the fiber coupler and the reference light interfere with each other to form interference light, which is detected by the photodetector. The operating section generates tomographic image data of the measurement object on the basis of the interference light detected by the photodetector, and outputs the data.

The OCT device enables an image with high resolution of the interior of a measurement object in a nondestructive and noncontact manner. The suitable applications that have been published include general objects and a living body, a human body in the fields of medical service such as ophthalmology, dermatology, endoscopes, and dentistry.

The Patent Documents 1-3 disclose methods of incorporating an OCT device into conventional dental equipment in a case of application to dentistry. In one of the disclosed configurations, the gripping position and direction of the measurement probe can be set freely by use of an optical fiber cable or a power-signal line. The documents state also how to perform the scanning in the depth direction (z-direction) within a probe and how to emit measurement light from the probe. The Patent Document 4 discloses a Fourier domain type optical coherence tomography device that scans wavelength of a light source, and further refers to the wavelength region, the probe configuration and the like. Patent Documents 5-8 suggest incorporation of a probe into a dental handpiece. The Non-Patent Documents 1-10 make reports on picturing performance in a case of applying the optical coherence tomography device to dentistry.

All of the OCT devices applied to dentistry are the OCT devices that have been utilized or researched, developed and published in ophthalmology and the fields other than dentistry. The basic structures of these OCT devices are identical to those of the conventional OCT devices as mentioned above.
Patent Document 1: JP 2004-344260 A
Patent Document 2: JP 2004-344262 A
Patent Document 3: JP 2004-347380 A
Patent Document 4: JP 2006-191937 A
Patent Document 5: JP 3118718 U
Patent Document 6: JP 3118823 U
Patent Document 7: JP 3118824 U
Patent Document 8: JP 3118839 U
Non-Patent Document 1: Laser review October, 2003: Technical development of optical coherence tomography for clinical application
Non-Patent Document 2: Journal of Biomedical Optics, October 2002, Vol. 7 No. 4: Imaging caries lesions and lesion progression with polarization sensitive optical coherence tomography
Non-Patent Document 3: APPLIED OPTICS, Vol. 37, No.16, 1 Jun. 1998: Imaging of hard- and soft-tissue structure in the oral cavity by optical coherence tomography
Non-Patent Document 4: OPTICS EXPRESS, Vol. 3, No. 6, 14 Sep. 1998: Dental OCT
Non-Patent Document 5: OPTICS EXPRESS, Vol. 3, No. 6, 14 Sep. 1998: In vivo OCT Imaging of hard and soft tissue of the oral cavity
Non-Patent Document 6: Abstracts in Optics & Photonics Japan 2004 by Optical Society of Japan, 5aF6, Measurement of dental samples by means of Fourier Domain Optical Coherence Tomography
Non-Patent Document 7: Abstracts in Optics & Photonics Japan 2005 by Optical Society of Japan, 24pE5, Application of Spectral Coherence Tomography to Three-Dimensional Dental Measurement
Non-Patent Document 8: Photonics West 2006, 6079-66, In-Vivo three dimensional Fourier Domain Optical Coherence Tomography for soft and hard oral tissue measurements
Non-Patent Document 9: Photonics West 2006, 6137-03, Assessment of dental-caries using optical coherence tomography
Non-Patent Document 10: Journal of Dental Research 85(9)2006, Remineralization of Enamel Caries Can Decrease Optical Reflectivity

In the above-mentioned OCT, it is required to increase the depth (penetration) of a measurable object. In light of this, examples of calculation of penetration in an OCT device is stated below.

It is assumed here that the measurement object is homogeneous. When light having a light source intensity I₀ enters the measurement object, the intensity I of backscattered light at a measurement depth z can be calculated as I=RI₀ exp(−μz)exp(−μz). Here, R denotes a backscattering rate, and μ denotes an attenuation coefficient. Therefore, when z₁ denotes a measurement depth in a case where the light source intensity is I₀ and the intensity of backscattered light becomes S/N critical intensity I_{S=N}, the I_{S=N} can be represented by the Formula (1) below for example.

[Numerical Formula 1]

I_{S=N}=RI₀ exp(−μz₁)exp(−μz₁)=RI₀ exp(−2μz₁) (1)

Similarly, when the light source intensity is a multiple of K (light source intensity=KI₀), the S/N critical intensity I_{K} of the backscattered light can be represented by the Formula (2) below. In the Formula (2), z_{K} denotes a measurement depth for the case where the S/N critical intensity is I_{K}.

[Numerical Formula 2]

I_{S=N}=KRI₀ exp(−2μz_{K}) (2)

From the above Formulae (1) and (2), the relational expression below is obtained.

$$\begin{matrix}[ Numerical formula 3 ] & \\ {RI}_{0} exp ( - 2 μ {z}_{1} ) = {KRI}_{0} exp ( - 2 μ {z}_{K} ) \\ ∴ exp ( - 2 μ {z}_{1} ) = K exp ( - 2 μ {z}_{K} ) \\ = exp ( ln K ) exp ( - 2 μ {z}_{K} ) \\ = exp ( - 2 μ {z}_{K} + ln K ) \\ ∴ - 2 μ {z}_{1} = - 2 μ {z}_{K} + ln K \\ ∴ {z}_{K} = \frac{1}{2 μ} ( 2 μ {z}_{1} + ln K ) = {z}_{1} + \frac{ln K}{2 μ} = {z}_{1} + Δ z \\ ∴ Δ z = \frac{ln K}{2 μ} & ( 3 )\end{matrix}$$

The final Formula (3) above indicates that the increase Δz of penetration at the time of multiplying the measurement light by K relies considerably on the attenuation coefficient μ.

Among the light beams in a wavelength range useful for an OCT device, for a light beam having a wavelength of 1.3μ that is the smallest attenuation coefficient μ with respect to human skin, μ≈3 [mm⁻¹], for example. Therefore, when the measurement light is doubled, the penetration becomes deeper by 0.116 mm. For example, for a case of tooth germ hard tissue whose attenuation is considered smaller than that of skin, it is assumed that μ=1 [l/mm], the penetration becomes deeper by 0.346 mm when the measurement light is doubled. In contrast, in order to increase the depth of penetration by Δz, the light source intensity should be multiplied by K in accordance with the Formula (4) below.

[Numerical Formula 4]

K=exp(2μΔz) (4)

Namely, for a case where the measurement object is the skin, the light source intensity should be multiplied by 163000 times for increasing the penetration by 2 mm. In a case where the measurement object is a tooth germ hard tissue (for example, where μ=1 [l/mm]), the light source intensity should be multiplied by 54.6 times for increasing the penetration by 2 mm.

As described above, the penetration relies on the attenuation coefficient μ of the measurement object tissue. And in a conventional OCT device, the maximum penetration is only about 3 mm even by using a light source having an existing maximum output, even for a case where the measurement object is a tooth germ tissue that has a relative high light transmission. For the purpose of increasing the light source intensity so as to increase the penetration, there is a necessity of using expensive SLD (Super Luminescent Diode) or considerably expensive variable wavelength laser source, which will raise the price of the OCT device.

The penetration is restricted mainly by noise. Noise is mixed or generated at every part of the OCT device. The examples include dark noise that occurs in a photodetector (in many cases a photodiode, a CCD, or a CMOS imaging device) for detecting interference light, and electric/magnetic/electromagnetic noise that occurs in the electronic circuit of the OCT device. Penetration corresponds to the depth of the measurement object where a signal caused by interference light becomes as small as the noise.

### SUMMARY OF THE INVENTION

Therefore, with the foregoing in mind, it is an object of the present invention to provide a coherence tomography device that can increase the penetration, namely, that can obtain information at a deeper site of a measurement object.

An optical coherence tomography device according to the present invention includes: a light source; a light splitting section that splits light-source light emitted from the light source into reference light with which a reference mirror is irradiated and measurement light with which a measurement object is irradiated; an interfering section that allows backscattered light of the measurement light backscattered by the measurement object to interfere with the reference light reflected from a reference mirror so as to generate interference light; a photodetecting section that measures the interference light; an oscillator that modulates the backscattered light and the interference light by applying an ultrasonic wave, a sonic wave or an oscillation to the measurement object; a demodulating section that demodulates the interference light measured at the photodetecting section; and an analyzing section that generates property data showing the optical backscattering property of two-dimensional or three-dimensional region at at least one part of the surface and the interior of the measurement object on the basis of the demodulated interference light, and generates image data regarding at least one of the structure, composition and material in the region of the measurement object on the basis of the property data.

Since the measurement object is oscillated by the oscillator, the backscattered light of the measurement object also is modulated. As a result, interference light generated by the interference between the backscattered light and the reference light is modulated. The interference light is demodulated by the demodulating section. In the modulation process, certain properties of the backscattered light and the interference light are changed by the oscillator. In the demodulation process, information of the interference light having the substantially same property as that of the light before the modulation is derived. Thereby, even when the intensity of the interference light is on the same level as the noise, the interference light components can be extracted. In this manner, the analyzing section generates property data and image data for the measurement object on the basis of the interference light from which noise has been eliminated. As a result, the penetration can be increased. Namely, a tomogram of a deeper site of the measurement object can be obtained.

According to the coherence tomography device of the present invention, it is possible to obtain information on a deeper site of a measurement object, i.e., it is possible to increase the penetration.

### BRIEF DESCRIPTION OF THE DRAWING

These and/or other aspects and advantages of the invention will become apparent and more readily appreciated from the following description of the embodiments, taken in conjunction with the accompanying drawing of which:

FIG. 1 is a diagram showing an example of a basic configuration of an optical coherence tomography device.

### DETAILED DESCRIPTION OF THE INVENTION

In an embodiment of the present invention, the demodulating section can be configured to demodulate the interference light by subjecting the interference light to a synchronous detection by using a signal whose frequency and phase are equal to those of an oscillation applied by the oscillator to the measurement object.

In the embodiment of the present invention, the coherence tomography device can include further an oscillation controlling section that applies the oscillator with a driving signal, thereby varying periodically at least one of the amplitude and the frequency of the oscillation applied to the measurement object so as to modulate the oscillation and thus causing a secondary modulation on the backscattered light and the interference light, where the demodulating section performs the demodulation and also a secondary demodulation with respect to the secondary modulation of the interference light.

The demodulating section demodulates the interference light and further performs a secondary demodulation. Namely, the interference light is modulated double and demodulated double. Thereby it is possible to further increase the depth of penetration.

In the embodiment of the present invention, the demodulating section can be configured to perform the secondary demodulation by performing a synchronous detection with respect to the secondary modulation, using a signal whose frequency and phase are equal to those of the secondary modulation caused by the driving signal.

In the embodiment of the present invention, the oscillator can be an ultrasonic source that emits an ultrasonic wave to the measurement object. Further the analyzing section can be configured to generate acoustic property data showing an acoustic impedance property of the measurement object on the basis of the frequency of modulation of the interference light caused by the oscillator, and to generate image data regarding at least one of the structure, composition and material of the measurement object on the basis of the acoustic property data.

The modulation to the backscattered light from the measurement object, which is caused by the oscillation of the ultrasonic source, reflects the acoustic impedance property of the measurement object. That is, the modulation frequency reflects the acoustic impedance property of the measurement object. Therefore, an acoustic analyzing section can calculate acoustic property data showing the acoustic impedance property of the measurement object, on the basis of the frequency of the modulation. As a result, it is possible to obtain images of the structure, composition, material and the like of the surface or the interior of the measurement object, which are provided due to the acoustic impedance property.

### First Embodiment

### <Configuration Example of OCT Device>

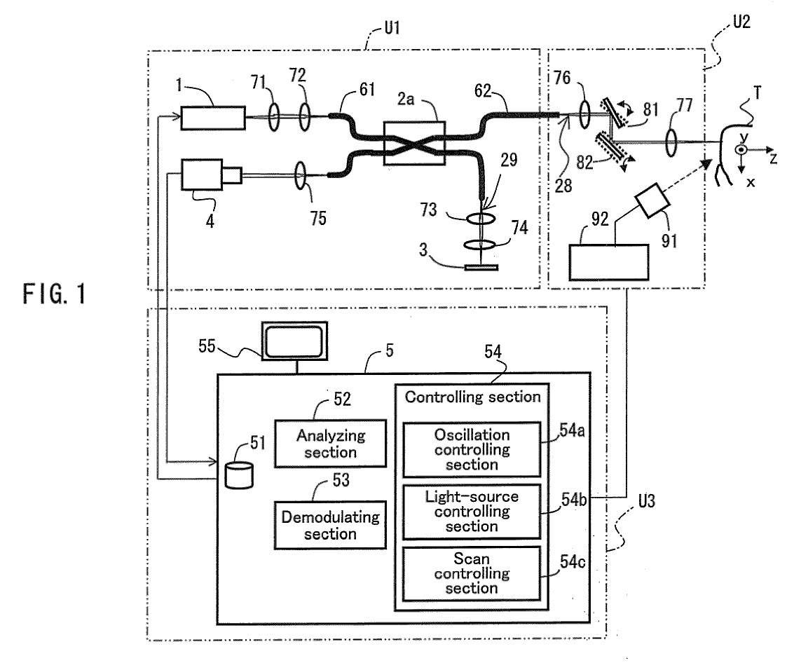

FIG. 1 is a diagram showing a basic configuration of an OCT device according to the present embodiment. The OCT device as shown in FIG. 1 is composed of an OCT unit U1, a probe unit U2 and a PC unit U3. The OCT unit includes, as main elements, a light source 1 that is low-coherent or coherent in terms of time, a fiber coupler 2a (serving as light splitting section and an interfering section), a reference mirror 3, a photodetector 4 (a photodetecting section) and lenses 71-75.

The fiber coupler 2a splits the light emitted by the light source 1 into the reference light traveling to the reference mirror 3 and measurement light traveling to the measurement object T. The measurement light is outputted to the probe unit U2, and the measurement object T is irradiated with the measurement light. A reflected component (backscattered light component) among the measurement light that has entered the measurement object T is guided back to the fiber coupler 2a. The fiber coupler 2a allows this backscattered light to interfere with the reference light that has been reflected back from the reference mirror 3, and outputs the thus obtained interference light to the photodetector 4.

In the following description, light-source light denotes a light beam emitted from the light source 1 to the fiber coupler 2a; the reference light denotes a light beam coming from the fiber coupler 2a to the reference mirror 3, and then reflected by the reference mirror 3 so as to return to the fiber coupler 2a; the measurement light denotes a light beam coming from the fiber coupler 2a to a measurement object T; the backscattered light denotes a light beam reflected by every part of the measurement object T so as to return to the fiber coupler 2a; and, the interference light denotes a light beam coming from the fiber coupler 2a to the photodetector 4 and the light source 1.

For convenience in explanation, a z-direction denotes a direction the measurement light travels, and x-direction and y-direction respectively denote directions in planes perpendicular to the z-direction (see the coordinate system shown in the vicinity of the measurement object T in FIG. 1). The x-axis and the y-axis cross each other at right angles.

Further, P-mode denotes an operation for obtaining data at the center of the coherence at which the optical path difference between the measurement light and the reference light becomes zero. A-mode denotes an operation for obtaining linear data in the z-direction. B-mode denotes an operation for obtaining tomographic data of a two-dimensional cross section in the z-direction and x-direction, and C-mode denotes an operation for obtaining a three-dimensional data in the z-, x- and y-directions by scanning in the y-directions on the respective tomograms of the B-mode.

As described above, the fiber coupler 2a is an example of an optical interferometric apparatus that functions as a light splitting section and also as an interfering section. The optical interferometric apparatus is an input-output switchable optical element that causes two input lights to interfere with each other, and outputs them in two directions. The fiber coupler 2a has optical fibers 61 and 62 used for input/output of light. Further, lenses 71-75 are provided for the purpose of collimating or focusing the light-source light, the reference light and the interference light. Examples of the optical interferometric apparatus other than the fiber coupler include a beam splitter and a half mirror. The photodetector 4 is an example of a photodetecting section. For the photodetector 4, a photodiode is used for example.

The probe unit U2 has a function of guiding the measurement light that has been outputted from the fiber coupler 2a of the CCT unit U1 to the measurement object T and irradiating the measurement object T with the measurement light, and receiving backscattered components (reflected components) composing a part of the measurement light entering the measurement object T and guiding to the fiber coupler 2a. Therefor, the probe unit U2 includes a galvano mirrors 81, 82, and lenses 76, 77. For example, the lenses 76, 77 focus the measurement light and collimate the backscattered light.

In the present embodiment, for example, the galvano mirror 81 scans the measurement light in the x-direction and the galvano mirror 82 scans the measurement light in the y-direction. The scanning is controlled by a controlling signal from a scan controlling section 54 of a computer 5 mentioned below. Here, the scanning for obtaining information of the measurement object T in the z-direction can be performed by driving the reference mirror 3 in the optical axis direction. This method is called a reference mirror driving method (so-called time-domain method).

To the probe unit U2, further an ultrasonic oscillator 91 and a controller 92 for the ultrasonic oscillator 91 are provided. The ultrasonic oscillator 91 generates an ultrasonic wave and transmits the ultrasonic wave to the measurement object T. Thereby, a demodulation is added to the backscattered light. For the ultrasonic oscillator 91, for example, a piezoelectric oscillator or the like is used. For the frequency of the ultrasonic wave, the range of 1 MHz to 100 MHz is preferred from the viewpoint of ultrasonic transmittance and the reflectance to human body.

Light transmission between the probe unit U2 and the OCT unit U1 is performed through the optical fiber 63. Thereby, the position and the direction of the probe unit U2 are not limited by the position and direction of the OCT unit U1, but they can be changed in a flexible manner in accordance with the condition of the measurement object T.

The PC unit U3 includes a computer 5 such as a personal computer and a displaying section 55 for example. The computer 5 has a recording section 51, an analyzing section 52, a demodulating section 53 and a controlling section 54. The controlling section includes an oscillation controlling section 54a, a light source controlling section 54b and a scan controlling section 54c. The functions of the respective sections are obtained when a CPU provided to the computer 5 executes a predetermined program. The recording section 51 is provided as a recording medium such as a semiconductor memory and a hard disc. The displaying section 55 is provided for example as a liquid crystal display, a CRT, a PDP, a SRT and the like.

The demodulating section 53 demodulates modulated interference light that has been detected by the photodetector 4. The analyzing section 52 analyzes the interference light demodulated by the demodulating section 53 and generates property data showing an optical backscattering property in a two-dimensional or three-dimensional region of the surface or the interior of the measurement object T. Further, the analyzing section 52 generates image data regarding at least one of the structure, composition and material in the region of the measurement object T on the basis of the property data, and output the data to the displaying section 55. The property data and the image data are recorded suitably on the recording section 51.

The oscillation controlling section 54a sends a driving signal for controlling the frequency and the phase of the oscillator 91, to the controller 92 of the probe unit U2. The light source controlling section 54b sends a controlling signal to the light source 1. The scan controlling section 54c sends controlling signals to the galvano mirrors 81, 82 of the probe unit U2 and to the reference mirror 3 of the OCT unit U1, thereby scanning the measurement light in the respective x-, y- and z-directions. The demodulating section 53 can acquire the driving signal of the oscillation controlling section 54a, generate a signal having a frequency and a phase equal to those of an ultrasonic wave generated by the oscillator 91 so as to use the signals for a demodulation process.

As mentioned above, the OCT device according to the present embodiment includes an oscillator that transmits an ultrasonic wave to the measurement object T. Furthermore, this OCT device includes the demodulating section 53 that demodulates the interference light detected by the photodetector 4 and outputted from the OCT unit 1, synchronously with the driving signal to be fed to the oscillator. Thereby, it becomes possible to modulate the interference light with an ultrasonic wave and demodulate the measured interference light signal with a demodulation ultrasonic wave signal. As a result, as mentioned below, it is possible to increase the penetration.

The configuration of the OCT device is not limited to the above-mentioned configuration. For example, the demodulating section 53 can be provided to the OCT unit 1 instead of the computer 5. In this case, the demodulating section 53 is provided for example as a signal processing circuit that demodulates the signal of the interference light intensity outputted by the photodetector 4 and transmits the signal to the PC unit U3.

Further, for example, two or all of the three units of the OCT unit U1, the probe unit U2 and the PC unit U3 can be formed as one unit.

(Operation Example of OCT Device)

Operation examples of the OCT device according to the present embodiment will be described below.

First, in the OCT unit U1, light-source light emitted from the light source 1 is collimated by the lenses 71, 72 and reaches the fiber coupler 2a. At the fiber coupler 2a, the light-source light is split into two beams of reference light and measurement light. The reference light is reflected by the reference mirror 3 and returns to the fiber coupler 2a. The measurement light is subjected to actions of reflection, scattering and transmission on the surface and inside the measurement object T, and thus backscattered light that composes a part of the measurement light returns to the fiber coupler 2a. This backscattered light carries backscattering coefficient information for the respective parts (for example, the respective parts of the measurement object T transformed on the temporal axis in the z-direction) of the surface and the interior of the measurement object T as the object reflected light in the z-direction.

This backscattered light and the reference light that has returned to the fiber coupler 2a are interfered with each other by the fiber coupler 2a, then become interference light to be split and emitted to the light source 1 and to the photodetector 4. The photodetector 4 detects the intensity of this interference light.

The light source 1 is low coherent in terms of time. Light beams emitted at different times from a light source that is low coherent in terms of time are very unlikely to interfere with each other. Therefore, an interference signal appears only when the distance of an optical path through which the measurement light and the backscattered light pass is substantially equal to that of an optical path through which the reference light passes. Consequently, when the intensity of an interference signal is measured by the photodetector 4 while a difference between the optical path length of the measurement light and the backscattered light and the optical path length of the reference light is changed by moving the reference mirror 3 in an optical axis direction of the reference light, a reflectance distribution (backscattering rate distribution) in a measurement light incident direction (z-direction) of the measurement object T can be obtained. That is, the structure in the depth direction of the measurement object T can be observed by scanning the optical path length difference.

As described above, the backscattered light carries, on its waveform as the electromagnetic wave, the information of the measurement object T. However, since the optical phenomena are extremely speedy, there is no photodetector that can measure directly the optical waveform on the temporal axis. However, by allowing the backscattered light to interfere with the reference light, the backscattering property information of the respective parts of the measurement object T is transformed to the change in the light intensity. Therefore, by detecting the intensity of the interference light with the photodetector 4, it will be possible to detect the distribution of the backscattering property of the measurement object T in z-direction on the temporal axis.

The ultrasonic wave generated by the oscillator 91 penetrates the interior of the measurement object T. The fact that the ultrasonic wave penetrates in the measurement object T indicates that the living body tissue oscillates at the ultrasonic frequency. The frequency of the oscillation is the frequency f of the generated ultrasonic wave. When the acoustic impedance at the incident part of the measurement object T is Z and the acoustic pressure of the ultrasonic wave is p, the oscillation velocity of the measurement object T is expressed as vᵣₘₛ (rms value)=p/Z. As a result, the oscillation velocity v (instantaneous value) of the measurement object T also changes in accordance with the acoustic impedance.

In a case where the measurement object T oscillates with an ultrasonic wave at a velocity of v when it is irradiated with the measurement light having a wavelength λ, the wavelength of the backscattered light from the measurement object T will experience a Doppler shift to λ(1±v/c) (v denotes an instantaneous value). Therefore, the rms value of this Doppler shift will be λvᵣₘₛ/c (vᵣₘₛ is the rms value). This Doppler shift causes an amplitude modulation (amplitude swell caused by superposition of waves having wavelengths slightly different from each other) of the interference light with the reference light in a time-domain OCT device. Therefore, the swell frequency of the amplitude modulation in the interference light reflects the acoustic impedance property of the living body tissue with respect to the ultrasonic wave. Namely, regarding the interference light, the intensity (amplitude) carries the information of the backscattering property (backscattering coefficient of the tissue) of the measurement object T as an ordinary OCT device and further information on the acoustic impedance property of the measurement object T with respect to the ultrasonic wave.

The photodetector 4 detects the interference light thus subjected to the amplitude modulation, and converts the light to a signal representing a temporal change of the intensity of the interference light. Through demodulation and analysis of this signal, the PC unit U3 can obtain a tomographic image of a deeper site of the measurement object T. Hereinafter, an example of the demodulation process will be described in detail.

Similarly to light beam, the ultrasonic wave attenuates in accordance with the depth after entering the measurement object T and the acoustic impedance of the tissue through which the ultrasonic wave has passed. However, the attenuation factor of the ultrasonic wave is smaller that that of light, and thus, the ultrasonic wave will reach the deeper site of the measurement object without attenuation in comparison with the case of light.

On the other hand, the backscattered light attenuates in accordance with the depth of the site of the backscatter in the measurement object T even when it causes a Doppler shift due to the ultrasonic wave. The attenuation degree is larger in comparison with the case of ultrasonic wave. Therefore, as described above, in a conventional OCT device, a signal of backscattered light at a depth at which the signal intensity of the backscattered light is in a level equal to the noise cannot be captured as an effective signal.

Here, in a case where the backscattered light modulated due to the Doppler shift, the components of the backscattered light intensity can be extracted by demodulating (e.g., synchronous detection) the signal of interference light detected by the photodetector 4. Namely, even when the noise is larger than the components of the backscattered light, the intensity of the backscattered light can be captured by synchronously detecting the interference light signal (although it is performed through the coherent action with the reference light). In this manner, the penetration of the OCT device can be increased remarkably.

The synchronous detection of an interference light signal is executed in the following manner by the demodulating section 53 for example. First, a reference signal serving as a criterion for the ultrasonic wave (irradiated ultrasonic wave) transmitted by the oscillator 91 to the measurement object is sent from the oscillation controlling section 54a to the demodulating section 53. This reference signal has a frequency equal to that of the irradiated ultrasonic wave, and the phase difference has a certain relationship (the angle of advance or delay is constant). The frequency is indicated as ‘f’ and the phase is indicated as ‘θ’. Namely, the oscillation of the measurement object T synchronizes with this reference signal.

The demodulating section 53 generates an integral signal of “a signal of a product of interference light signal (signal of intensity of interference light detected by the photodetector 4) and a reference signal” and “a signal of a product of an interference light signal and a signal whose phase is different from that of a reference signal by π/2), as a complex signal. By generating an absolute value of the complex signal, the demodulating section 53 can extract an interference light signal free of noise.

As mentioned above, the synchronous detection is a detection method for extracting a component of a phase identical (differ from 0 degree or 180 degrees) to that of the reference signal (a minus component is extracted when the phase differ by 180 degrees). Therefore, the case where component of 90 degrees is reflected alone cannot be distinguished from the case where there is no reflection (reflection from infinity or non-reflection). Therefore, in the synchronous detection in the present embodiment, a method of detecting both the component at 0 degree (or component at 180 degrees) and the component at 90 degrees (or component at 270 degrees) is employed. Namely, both the sin component and the cos component are detected. Specifically, as mentioned above, the demodulating section 53 executes a process of squaring the sin component and the cos component respectively and subjecting to the time integration, taking the sum, and calculating the square root (absolute value). During the integration process, noise having different frequency is cancelled in terms of time and eliminated. Such a synchronous detection may be called generally a complex detection (vector detection).

The analyzing section 52 can obtain the backscattering rate distribution in the z-direction of the measurement object T from the interference light signal from which the noise component has been eliminated as a result of wave detection at the demodulating section 53. For executing the above-mentioned process, the oscillation controlling section 54a can be configured to have a reference signal generating circuit, and the demodulating section 53 can be configured to have for example a phase circuit, a multiplication circuit, an integration circuit, and a circuit that generates an absolute value from the complex signal. Alternatively, the above-mentioned processes in the demodulating section 53 and the analyzing section 52 can be performed as a result of the operation of the processor in accordance with a predetermined program (software).

The analyzing section 52 further can calculate the instantaneous value or the rms value of oscillation caused by ultrasonic waves at every part of the measurement object T, through a measurement on the frequency (for example, the frequency fᵤ of swell of the amplitude modulation) of the modulation (i.e., the wavelength of the backscattered light changes in synchronization with the oscillation caused by the ultrasonic wave) cased by the Doppler shift. Thereby, data that indicate the acoustic impedance property distribution for the measurement object T can be obtained. From the data, the acoustic impedance property of the measurement object T can be obtained as a tomographic image.

The analyzing section 52 may generate one tomographic image by using both the backscattering rate distribution in the z-direction of the measurement object T and the acoustic impedance property. Alternatively, it may generate a tomographic image based on the backscattering rate distribution and a tomographic image based on the acoustic impedance property respectively. The above description refers to an embodiment of the present invention, but the present invention is not limited to the embodiment. Variations of the embodiment will be described below.

(Configuration for Secondary Detection)

The oscillation controlling section 54a may modulate (secondary modulation) the amplitude or the frequency of the ultrasonic wave applied to the measurement object T by the oscillator 91. In this case, the demodulating section 53 executes a secondary detection corresponding to the secondary modulation on the interference light signal that has been subjected to a primary detection as mentioned above with the ultrasonic frequency. This secondary detection may be a synchronous detection using a reference signal synchronous with the frequency and the phase of the secondary modulation applied by the oscillation controlling section 54a. As a result of this secondary detection, the signal of the backscattered light buried in noise can be captured further, and the penetration can be increased further.

(Variation of Signal to be Synchronously Detected)

According to the above embodiment, the synchronous detection is performed on the interference light signal (intensity signal of interference light) detected by the photodetector 4. Alternatively, the synchronous detection can be performed on any other output, intermediate output, or internal input in the OCT unit U1. For example, it is possible to convert an intensity signal of interference light into intensity data of interference light processable with a computer, and this intensity data of interference light is subjected to a synchronous detection by using reference data obtained by converting the reference signal to be processable with a computer. In this case, a processor such as CPU processes the intensity data of the interference light and the reference data by using a predetermined program (software).

(Other Modulation-Demodulation Methods)

In the above-described embodiment, modulation-demodulation methods using amplitude modulation and synchronous detection, and a Doppler wavelength modulation, are employed. However, modulation-demodulation methods applicable to the present invention are not limited to this embodiment. Modulation methods are not limited particularly as long as the oscillator 91 is configured to change the properties such as the optical phase and light wavelength of the backscattered light so as to modulate the intensity and the wavelength of the interference light with the frequency of the ultrasonic wave (or a sonic wave) of the oscillator 91, and the demodulating section 53 derives, from the thus modulated interference light, a interference light having properties as substantially same as those of the interference light before the modulation (detecting the intensity of modulated interference light). For example, demodulation methods such as superheterodyne method can be employed.

(Variation of Oscillator)

Though the oscillator 91 generates ultrasonic waves in the above-mentioned embodiment, the oscillator 91 may oscillate the measurement object T with any means other than the ultrasonic wave. For example, the oscillator 91 may be a speaker that generates sonic waves. Thereby, when the measurement object T is a part of a tooth of a patient, the patient can recognizes the measurement timing by the sound, and thus it is possible for the patient to try not to move the tooth (measurement site) during the measurement.

(Ultrasonic Transmission Means)

In the above-mentioned embodiment, the ultrasonic oscillator 91 is assumed to irradiate the measurement object T with ultrasonic waves through air. However, it is possible to interpose an ultrasonic transmission member having excellent ultrasonic transmission between the ultrasonic oscillator 91 and the measurement object T. Thereby, attenuation of the ultrasonic wave can be prevented. Further, it is preferable to apply a jelly to the interface between the measurement object T and the ultrasonic transmission member, thereby preventing reflection, scattering and absorption of the ultrasonic wave on the interface.

(Variation of Z-Direction Scanning Means)

The above-mentioned embodiment refers to a case of applying a so-called time-domain method where the light source is a SLD (Super Luminescent Diode) and the reference mirror 3 is driven to obtain the interference light at every position of the reference mirror 3, thereby obtaining a backscattering coefficient property in the depth direction (z-direction) of the measurement object T corresponding to the position of the reference mirror 3. Another example for obtaining information (A-mode) in the z-direction is a spectral domain method (an example of Fourier domain method) where a diffraction grating is provided to the lens 75 at the output side, converts the temporal axis information in the z-direction to the space-axis information in the diffraction direction of the diffraction grating and detects the information at the photodetector 4. In this case, a one- or two-dimensional imager such as CCD can be used for the photodetector 4. At the analyzing section 52 of the PC unit U3, a process of reconstructing data showing the intensity distribution of the space-axis detected at the photodetector 4 into data showing the temporal axis information, namely z-direction information, through a calculation such as Fourier transformation.

Further, for the light source 1, a swept-source method (another example of Fourier domain method) using variable wavelength light source can be used.

As described above, even for a case of using these Fourier domain methods, the demodulating section 53 can demodulate similarly to the above-mentioned embodiment, by performing a synchronous detection on the signal of the interference light intensity distribution detected by the photodetector 4. For example, in a spectral domain OCT that uses SLD as the light source and that splits the interference light regarding the wavelength with the diffraction grating and detects the interference light, the optical signal of every wavelength of the split interference light (intensity signal of every wavelength of the split interference light) can be detected by synchronizing with the driving signal applied to the oscillator.

In an alternative type of OCT that uses a variable wavelength light source and scans repeatedly the wavelength of the measurement light in a predetermined range, the optical signal of interference light with respect to the respective wavelengths of the measurement light can be detected by synchronizing with the driving signal applied to the oscillator.

In such a Fourier domain type OCT, it is possible to convert the interference light signal corresponding to each wavelength into interference light data processable with a computer. Alternatively, it is possible to detect the interference light data by synchronizing with a driving signal applied to the oscillator 91.

Further, in such a Fourier domain type OCT, it is possible to subject the wavelength distribution of the interference light data corresponding to each wavelength to inverse-Fourier transformation on the wavelength so as to obtain time series distribution data (which indicate the distribution of backscattering coefficient of the measurement object T in the depth direction (z-direction)). Alternatively, it is possible to detect the data after the inverse-Fourier transformation, by synchronizing with the driving signal applied to the oscillator.

(Variation in Scanning in the X-, Y-Directions)

In the above-described embodiment, the scanning in the x- and y-directions (means for obtaining the B-mode and C-mode) is performed by using a galvano mirror. The methods for obtaining these modes are not limited particularly but various methods can be used therefor. In one example thereof, a B-mode image in the x-direction is obtained by making the point flux from a point light source as a linear flux by the cylindrical lens in addition to the A-mode in the z-direction obtained through the reference mirror scanning (cylindrical lens method). It is also possible to obtain a C-mode by combining the information acquisition in the x-direction by the cylindrical lens and the y-direction scanning by the galvano mirror. Further in this method, it is possible to employ the Fourier domain method in place of the reference mirror driving for the purpose of providing the A-mode.

Further it is possible to broaden the light from the light source two-dimensionally in a plane by using a lens, irradiate the measurement object T with a plane-measurement light flux by using a hollow optical system, thereby obtaining data on the xy surface (strictly, a spherical surface approximate to a xy surface) inside the measurement object at a depth having the same optical path length as that of the reference mirror 3. This method is called a full-field method, which is a special mode. A special C-mode operation, which is obtained by combining the full-field method with the A-mode scanning of the reference mirror driving, also is available.

(Variation of Fiber Coupler)

The fiber coupler can be replaced by a beam splitter 2b. In this case, the light source 1, the beam splitter 2b, the reference mirror 3, the lens 76 and the photodetector 4 should be arranged in an optically suitable manner. The optical fibers 61-64 are regarded not as essential but as optional elements. For a compact arrangement, it is possible to apply mirrors at some positions, or optical fibers can be used partly as required.

The present embodiment and the variations have been described above. According to the above embodiment, the OCT device includes an oscillator for applying oscillation to the measurement object T by using an ultrasonic wave or a sonic wave. The OCT device has a function of performing a detection synchronizing with a driving signal that applies an output, an intermediate output or an internal input in the OCT unit U1 to the oscillator. Further, it is possible to provide a configuration to modulate the driving signal by changing at least any one of the size or frequency of the driving signal to be applied to the oscillator. In that case, a function of performing a secondary detection of the output that has been subjected to a primary detection, in synchronization with the driving signal modulation, is provided.

In this manner, in the OCT device of the present embodiment, an interference measurement signal modulated first with the ultrasonic wave is then demodulated with the demodulation ultrasonic signal. Namely, in the OCT device, by irradiating the measurement object with the ultrasonic wave, Doppler modulation is provided to the backscattered light in the z-direction, and the thus obtained signal is demodulated on the basis of the modulation signal. Thereby, even a deep site of the measurement object, at which the light interference signal becomes small to be buried in the noise, can be photographed.

Specifically, the oscillator is oscillated with an ultrasonic wave so as to apply an ultrasonic wave, a sonic wave or an oscillation to the measurement object, and a detection is performed in synchronizing the output, intermediate output or internal input of the OCT device with the driving signal to be applied to the oscillator. Further, by applying a driving signal modulation by changing at least either the size or the frequency of the driving signal to be applied to the oscillator, an optimum modulation method for deepening the penetration can be selected. The penetration can be made still deeper by subjecting the thus detected output to a secondary detection in synchronizing with the driving signal modulation, namely, by modulating double and detecting double.

The OCT device according to the present embodiment can be used preferably in the field where tomographic images of a deeper site from the surface is required, in particular in the medical field including dentistry. In dentistry, X-ray equipment has been used widely for observing the interior of a periodontal region including the periphery of a dental root. Recently, CT equipment using X-ray applied exclusively to a maxillo-facial region has become widespread. Moreover, some research results and patents utilizing ultrasonic waves or normal optical coherence tomography devices have been presented and published. However, the X-ray has invasiveness to bodies of the patients or the operators, and equipment using only ultrasonic waves has drawbacks in the resolution. In view of this situation, OCT devices having high resolution has been proposed. However, the penetration is so small as the range of 2 to 3 mm as mentioned above. For the purpose of observing a periodontal region, a tooth interior and a dental root, a deeper penetration is required.

According to the present embodiment, it is possible to deepen the penetration of an OCT device that has been a subject of various researches and presentations and that has been used partly in ophthalmology or the like. Therefore, the OCT of the present embodiment has a high possibility to be used in a field such as dentistry that requires a deep penetration.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A coherence tomography device comprising:
a light source;
a light splitting section that splits light-source light emitted from the light source into reference light with which a reference mirror is irradiated and measurement light with which a measurement object is irradiated;
an interfering section that allows backscattered light of the measurement light backscattered by the measurement object to interfere with the reference light reflected from a reference mirror so as to generate interference light;
a photodetecting section that measures the interference light;
an oscillator that modulates the backscattered light and the interference light by applying an ultrasonic wave, a sonic wave or an oscillation to the measurement object;
a demodulating section that demodulates the interference light measured at the photodetecting section; and
an analyzing section that generates property data showing the optical backscattering property of two-dimensional or three-dimensional region at at least one part of the surface and the interior of the measurement object on the basis of the demodulated interference light, and generates image data regarding at least one of the structure, composition and material in the region of the measurement object on the basis of the property data.

2. The coherence tomography device according to claim 1, wherein the demodulating section demodulates the interference light by subjecting the interference light to a synchronous detection by using a signal whose frequency and phase are equal to the frequency and the phase of an oscillation applied by the oscillator to the measurement object.

3. The coherence tomography device according to claim 1, further comprising an oscillation controlling section that applies the oscillator with a driving signal, thereby varying periodically at least one of the amplitude and the frequency of the oscillation applied to the measurement object so as to modulate the oscillation and thus causing a secondary modulation on the backscattered light and the interference light; and
the demodulating section performs the demodulation and also a secondary demodulation with respect to the secondary modulation of the interference light.

4. The coherence tomography device according to claim 3, wherein the demodulating section performs the secondary demodulation by performing a synchronous detection with respect to the secondary modulation, using a signal whose frequency and phase are equal to the frequency and the phase of the secondary modulation caused by the driving signal.

5. The coherence tomography device according to claim 1, wherein
the oscillator is an ultrasonic source that emits an ultrasonic wave to the measurement object;
the analyzing section generates acoustic property data showing an acoustic impedance property of the measurement object on the basis of the frequency of modulation of the interference light caused by the oscillator, and generates image data regarding at least one of the structure, composition and material of the measurement object on the basis of the acoustic property data.
